(19) United States
(12) Patent Application Publication
(10) Pub. No.: US 2016/0273481 A1
(43) Pub. Date: Sep. 22, 2016

(54) CYLINDER HEAD FOR AN INTERNAL COMBUSTION ENGINE HAVING COOLANT CHANNELS

(71) Applicant: Dr. Ing. h.c.F. Porsche Aktiengesellschaft, Stuttgart (DE)

(72) Inventor: Frank Ickinger, Pleidelsheim (DE)

(21) Appl. No.: 15/072,498

(22) Filed: Mar. 17, 2016

(30) Foreign Application Priority Data
Mar. 17, 2015 (DE) 10 2015 103 905.2

(51) Int. Cl. F02F 1/38; F02F 1/24

(52) U.S. Cl. CPC F02F 1/38; F02F 1/242

(57) ABSTRACT

A cylinder head for an internal combustion engine has at least two outlet valves (1, 2), at least two inlet valves (3, 4), a spark or glow plug (6) arranged centrally between the valves (1, 2, 3, 4), and at least one injection valve (7). Coolant channels (8, 9, 10, 11, 12) accommodate a throughflow of the cylinder head with cooling liquid. The coolant channels (8, 9, 10, 11, 12) are arranged in the incident or surrounding flow region of the spark/glow plug (6) and injection valve (7) to run at a substantially acute angle in the flow direction toward the spark/glow plug (6) and injection valve (7).

### CROSS REFERENCE TO RELATED APPLICATION

This application claims priority under 35 USC 119 to German Patent Appl. No. 10 2015 103 905.2 filed on Mar. 17, 2015, the entire disclosure of which is incorporated herein by reference.

### BACKGROUND

1. Field of the Invention

The invention relates to a cylinder head for an internal combustion engine having at least two inlet valves and at least two outlet valves, a spark or glow plug arranged centrally between the valves, and at least one injection valve, and having coolant channels for the throughflow of the cylinder head with cooling liquid.

2. Description of the Related Art

Cylinder heads of particularly powerful internal combustion engines in passenger motor vehicle construction have coolant channels for throughflow of a cooling liquid. A channel system is formed in the cylinder head by way of cavities that are cast in or otherwise introduced. The channel system forms a cooling liquid jacket around valves, injectors, glow or spark plugs. Cooling liquid is fed either via external connectors on the cylinder head or via an interface to the crankcase of the internal combustion engine and cooling liquid guides that are present there. The aim is to avoid forming heat zones in the cooling liquid guiding system due to a reduced flow speed or, in the extreme case, as a result of a standstill of the flow of the coolant. Spark or glow plugs and injectors are to be arranged approximately centrally in the cylinder and therefore in a region, in which the arrangement and the course of the coolant channels encounters particular difficulties first on account of the constricted space conditions and second with regard to the requirements of the overall strength of the cylinder head.

A very wide variety of possible solutions for this cooling problem are known from the prior art. For instance, DE 103 21 035 B3 discloses a solution, in which the coolant flow is guided transversely with respect to the internal combustion engine longitudinal direction from the outlet side to the inlet side of the cylinder head and is divided into receiving shafts.

US 2013/0192546 A1 describes the division of the cooling circuit in the cylinder head of an internal combustion engine into a plurality of part coolant channel constructions that are arranged adjacently.

DE 10 2008 047 185 A1 describes coolant channels arranged in plural planes one above another in the cylinder head. This division is intended to achieve a particularly effective throughflow of the cylinder head with cooling liquid.

DE 1 251 586 describes forming cooling liquid channels in a cylinder head by way of an insert shell that is coaxial with the fuel injection nozzle. In this way, an expedient arrangement of the necessary coolant channels is achieved in constricted conditions.

Finally, JP 2004 218 593 A discloses the arrangement of cast fins in the coolant channels to influence the flow of the cooling water in the cylinder head.

It is an object of the invention to structurally improve the cooling liquid course in a cylinder head of an internal combustion engine in the particularly critical region of the centrally arranged spark or glow plug and an injection valve in order to achieve optimum cooling.

### SUMMARY

The invention relates to a cylinder head with coolant channels that are arranged to run at a substantially acute angle in the flow direction toward the spark or glow plug and/or injection valve in the incident or surrounding flow region of the spark or glow plug and/or injection valve.

The walls in the cylinder head that form the coolant channels may be shaped in the region of the spark/glow plug and/or injection valve to form a region that substantially encloses the spark/glow plug and/or injection valve tightly without influencing or diverting the flow.

Particularly effective cooling is achieved by way of said arrangement of the coolant channels that encloses the region of the spark or glow plug and injection valve and the incident flow of the region at an acute. The tightly bearing cooling liquid flow in said region that is critical in terms of heat solution of optimum design.

In one embodiment, the flow course in the coolant channels takes place from the gas outlet side (outlet valves) to the gas inlet side (inlet valves). Solutions in respect of the flow course or in respect of the course of the flow means channels from the gas inlet side (inlet valves) to the gas outlet side (outlet valves) or else the throughflow that runs transverse to the above-mentioned flow directions are likewise conceivable.

Details, features and further combinations of features with respect to the subject matter of the invention result from the following description of examples and the drawing. Exemplary embodiments of the subject matter of the invention are shown in a diagrammatically simplified manner in the drawing. The subject matter of the invention will be explained in greater detail in the following text using the exemplary embodiments.

### BRIEF DESCRIPTION OF THE DRAWINGS

FIG. 1 is a perspective view of an arrangement of outlet valves, inlet valves, spark plug and injection valve in the cylinder head of an internal combustion engine.

FIG. 2 is a plan view of the cylinder head according to FIG. 1 with the coolant channels indicated.

FIG. 3 shows the arrangement of the coolant channels or the flow course of the cooling liquid in the region of the valves, spark plug and injection valve.

FIG. 4 shows the flow course in the central region of the cylinder head around the spark plug or injection valve in accordance of the prior art.

FIGS. 5 and 6 diagrammatically show different solutions of the invention.

### DETAILED DESCRIPTION

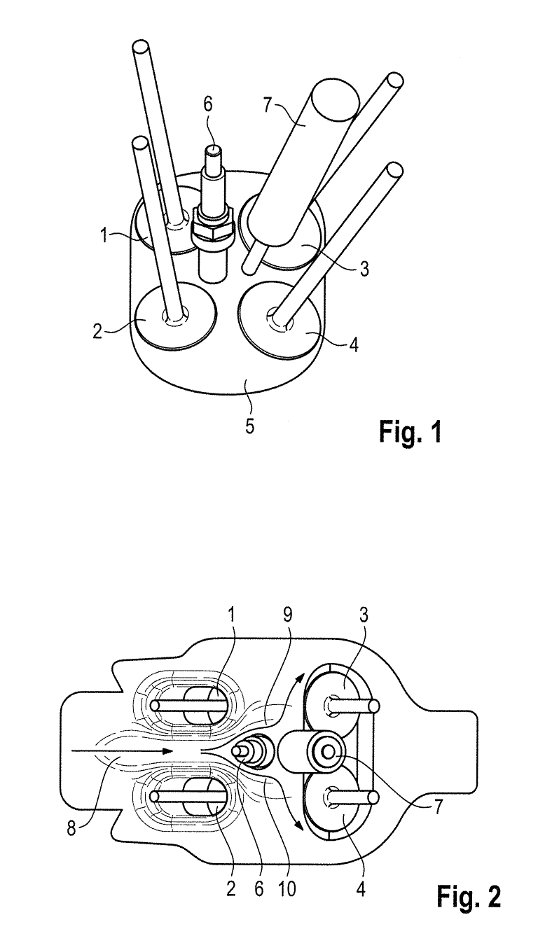

FIG. 1 is a perspective plan view of a cylinder head of an internal combustion engine having two outlet valves 1, 2 and two inlet valves 3, 4 arranged in the roof space 5 of the combustion chamber of the cylinder. A spark plug 6 and an injection valve 7 are arranged centrally in the roof region of a combustion chamber between the valves 1, 2, 3 and 4.

FIG. 2 is a plan view of the cylinder head of FIG. 1 having the outlet valves 1, 2 and the inlet valves 3, 4 and also having the spark plug 6 and injection valve 7 arranged to lie inward from between the outlet valves 1, 2 and the inlet valves 3, 4.

Coolant channels in this region of the cylinder head are shown by the arrows 8, 9 and 10 and indicate the course of the cooling liquid in the region.

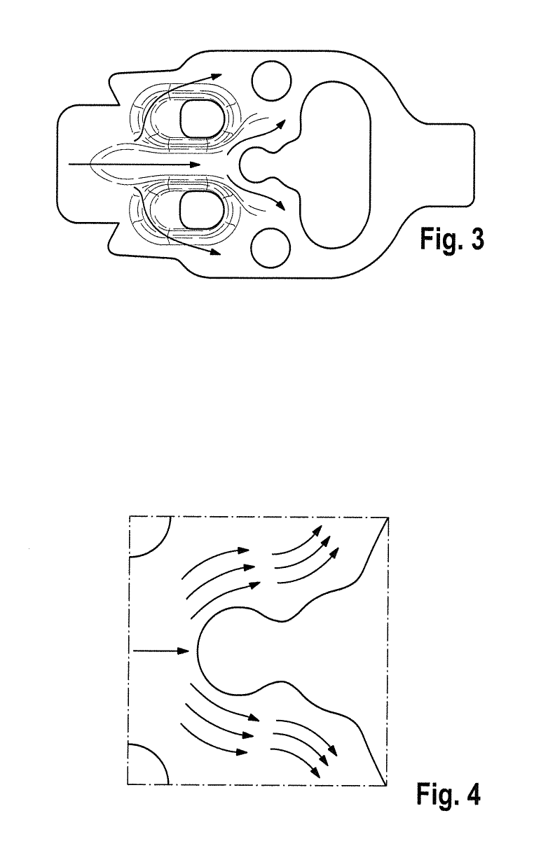

The spark plug 6 and injection valve 7 usually are produced and/or cast to have substantially cylindrical shapes and thus are fit in likewise cylindrical moldings within the cylinder head. FIG. 4 is a detailed illustration of the central region from FIG. 3 and make clear that an ideal flow and therefore effective cooling can scarcely be achieved in the case of a substantially circular channel wall known according to the prior art in the incident flow region of the cooling liquid for cooling the spark plug and injection valve. The arrows that illustrate the flow course in FIGS. 3 and 4 make clear that flow separation or eddying tends to take place in the critical regions rather than the flow liquid bearing against the channel wall, which is necessary for effective cooling.

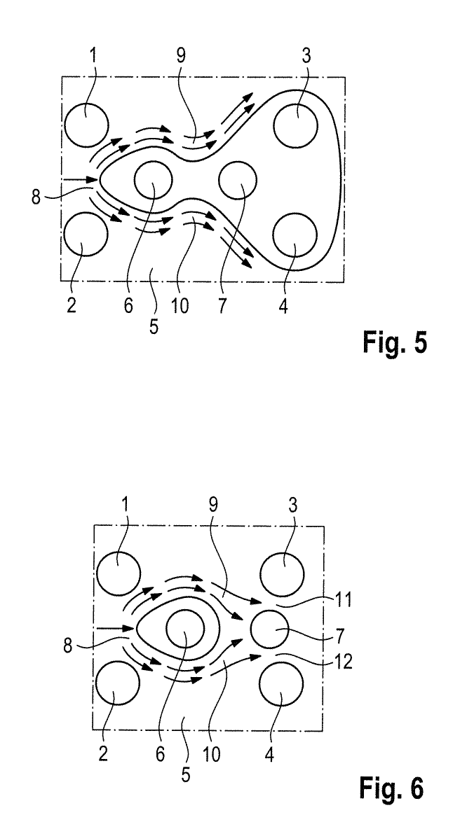

FIGS. 5 and 6 show the incident flow 8, 9 and 10 of the invention in the central region in which the spark plug 6 and injection valve 7 are accommodated. The incident flow 8, 9 and 10 is configured to run at a substantially acute angle in the flow direction toward the spark plug and injection valve. As a result the cooling liquid bears tightly against the walls of the coolant channels without substantial flow influencing or deflection in the region of the spark or glow plug 6 and injection valve 7. The tight bearing and substantially undisrupted flow course is shown by the arrows in FIGS. 5 and 6.

The throughflow of the coolant channels 8, 9 and 10 in the roof space 5 of a cylinder head ideally takes place from the side of the outlet valves 1 and 2, that is to say from the hot side, in the direction of the inlet valves 3 and 4 (see arrows in FIGS. 2, 5 and 6); the reverse flow course or else a transverse throughflow (perpendicularly with respect to the course of the arrows in FIGS. 2, 5 and 6) is likewise conceivable.

One particularly effective embodiment of the invention is shown in FIG. 6. As a result of the arrangement of coolant channels 11 and 12 between the injection valve 7 and inlet valves 3 and 4, particularly efficient cooling of said critical regions is achieved.

It is readily comprehensible to a person skilled in the art that the wall course of the coolant channels 8, 9, 10, 11, 12 can be selected depending on the structural and spatial conditions. In the context of the inventive solution, the cooling liquid flow bearing tightly in the region of the channel wall that surrounds the spark plug 6 and injection valve 7 is to be ensured.

What is claimed is:

1. A cylinder head for an internal combustion engine comprising at least two inlet valves, at least two outlet valves, a spark or glow plug arranged centrally between the valves, at least one injection valve, and coolant channels for a throughflow of the cylinder head with cooling liquid, the coolant channels being arranged in the incident or surrounding flow region of the spark/glow plug and injection valve so as to run at an acute angle in the flow direction toward the spark/glow plug and injection valve.

2. The cylinder head of claim 1, wherein the walls in the cylinder head that form the coolant channels are arranged in the region of the spark/glow plug and injection valve to substantially enclose the region tightly.

3. The cylinder head of claim 1, wherein a cooling liquid inlet into the coolant channels in the cylinder head is arranged on a side of the cylinder head having the outlet valves.

4. The cylinder head of claim 1, wherein a cooling liquid inlet into the cooling channels in the cylinder head is arranged on a side of the cylinder head having the inlet valves.

5. The cylinder head as claimed in claim 1, wherein a cooling liquid inlet into the cooling channels in the cylinder head is arranged between one of the inlet valves and one of the outlet valves.
